(19) United States
(12) Patent Application Publication
(10) Pub. No.: US 2004/0064700 A1
(43) Pub. Date: Apr. 1, 2004

(54) Method for identification based on bilinear diffie-hellman problem

(76) Inventors: Myungsun Kim, Seoul (KR); Kwangjo Kim, Seoul (KR)

Correspondence Address: ANDERSON KILL & OLICK, P.C., 1251 Avenue of the Americas, New York, NY, 10020-1182, US

(21) Appl. No.: 10/600,560

(22) Filed: Jun. 19, 2003

(30) Foreign Application Priority Data
Sep. 18, 2002 (KR) 10-2002-56937

(51) Int. Cl. H04L 9/00

(52) U.S. Cl. 713/170

(57) ABSTRACT

A method for identification includes the steps of generating system parameters, a private key and a public key, random numbers for obtaining an evidence, sending the evidence to a verifier by a prover, selecting a randomly selected number to obtain a query and sending the query R to the prover by the verifier, computing a temporary value to obtain a response and sending the response to the verifier by the prover, and determining a legitimacy of the prover by employing the system parameters, the public key, the evidence and the randomly selected number by the verifier. The method provides an identification scheme based on discrete logarithm problem, requiring no certificate and including only one query-and-response procedure.

### FIELD OF THE INVENTION

The present invention relates to an identification scheme; and, more particularly, to a method for user identification in network environments, based on the bilinear Diffie-Hellman problem.

### BACKGROUND OF THE INVENTION

Currently, diverse off-line services are expanding their ranges to cyberspace through internet as a result of steady development of network environments. In cyberspace, remote non-face-to-face interconnections can be made anytime and anywhere. However, such non-face-to-face circumstances bring about an identification (ID) problem of distinguishing legitimate users from illegitimate-ones. In general, an identification scheme means a cryptographic technique employed to solve an identification problem in non-face-to-face circumstances such as cyberspace interactions.

A most basic identification scheme uses identification (ID) information particular to each user and password information only one user knows. Most UNIX operating systems employ this type of scheme. However, this scheme leaves room for masquerade attacks because a user's password can be easily exposed during its transmission through a communication channel.

In order to overcome the drawback described above, identification schemes employing public-key cryptographic system have been developed. This scheme is applied to such fields as, for example, cyberbanking. In a public-key cryptographic system, a public key and a private key are used. Typcally, the private key is known to nobody except its owner, and the public key is available to public. A prover, who is expected to know the private key, requests a service to a verifier. The prover tries to prove himself a legitimate user by showing that he knows the private key corresponding to the public key, while not divulging the private key. And the verifier tries to verify the prover's legitimacy only by utilizing information disclosed by the prover.

Identification schemes employing the public-key cryptographic system based on number theory can be classified into two categories, i.e., one based on the factorization problem, e.g., the Fiat-Shamir scheme, and the other, e.g., the Schnorr scheme, based on the discrete logarithm problem.

The procedure of the Fiat-Shamir scheme can be expounded as follows. A reliable system administrator selects a sufficiently large number n. Then, A prover selects his own private key a that is relatively prime with n, and calculates b=a² mod n. The prover discloses b. Then, the following protocol is repeated for a number of times:

(a) The prover selects a random integer r□Zₙ*, where Zₙ* is a multiplicative group of order n, calculates x=r², and sends x to the verifier;

(b) The verifier selects a random number □□{0, 1}, and sends □ to the prover;

(c) On receiving □, the prover calculates y=r□a^{□} mod n and sends y to the verifier; and

(d) The verifier examines whether y²=x□b^{□} mod n is established. If true, then the verifier accepts the prover as a legitimate user and, otherwise, stops the protocol.

Various schemes have been developed based on the original Fiat-Schamir scheme, and follows the above-mentioned protocol.

On the other hand, the procedure of the Schnorr scheme is as follows. First, two primes numbers p and q are chosen, wherein q is a prime factor of p−1. Then, choose a not equal to 1, such that a^{q}□1 (mod p). Then, a random number s, i.e., the private key, less than q is chosen. The public key v=a^{-s} mod p is then calculated. Thereafter, the following protocol is executed:

(a) The prover selects a random number r less than q, and computes x=a^{r} mod p, then sends x to the verifier;

(b) The verifier sends the prover a random number □□z_{q}* , where Z_{q}* is a multiplicative group of order q;

(c) The prover computes y=r+s□ mod q and sends y to the verifier; and

(d) The verifier verifies whether x=a^{y}□v^{□} mod p is established. If true, then the verifier accepts the prover as a legitimate user and, otherwise, stops the protocol.

However, the aforementioned schemes have the following drawbacks. As for the Fiat-Shamir scheme, three demerits may be pointed out. First, its security proof is too intricate to demonstrate. The security of the Fiat-Shamir scheme has been proved by employing an interactive zero-knowledge proof based on complexity theory, which is too complicated to be grasped intuitively. Most state-of-the-art schemes based on the Fiat-Shamir scheme also employ the zero-knowledge proof to show their security. Second, a query-and-response procedure needs to be reiterated a number of times between the prover and the verifier, thereby causing computational overheads. Third, this scheme is based on prime factorization problem, which needs longer keys than those of discrete-logarithm-problem-based schemes.

On the other hand, the Schnorr scheme has also two major shortcomings. First, this scheme requires a certificate, which has difficulties in its verification and revocation. Second, this scheme is practical only when an identification is performed among systems which have greatly different computing powers, e.g., a server and a client, but not between a server and another server.

### SUMMARY OF THE INVENTION

It is, therefore, an object of the present invention to provide an identification scheme based on discrete logarithm problem, requiring no certificate and including only one query-and-response procedure, of which security can be proved in an easily apprehensible way.

In accordance with a preferred embodiment of the present invention, there is provided a method for identification, including the steps of: (a) generating system parameters G₁, G₂, P and ê and storing the system parameters in a memory by a system administrator, wherein G₁ and G₂ are cyclic groups of order m, P is a generator on the cyclic group G₁, ê is a bilinear map defined as ê: G₁×G₁ [symbol] G₂; (b) generating a private key <a, b, c> and a public key v and storing the public key v in the memory by a prover or the system administrator, wherein a, b and c are randomly chosen in Zₘ* where Zₘ* is a multiplicative group of order m; (c) generating random numbers r₁, r₂, r₃∈Zₘ* for obtaining an evidence (x, Q) and sending the evidence (x, Q) to a verifier by the prover; (d) receiving the evidence (x, Q), selecting a randomly selected number ω□Zₘ* to obtain a query R, storing the evidence (x, Q) and the randomly selected number ω in the memory and sending the query R to the prover by the verifier; (e) receiving the query R, computing a temporary value S to obtain a response Y and sending the response Y to the verifier by the prover; (f) determining a legitimacy of the prover by employing the system parameters G₁, G₂, P and ê, the public key v, the evidence (x, Q) and the randomly selected number ω by the verifier.

In accordance with another preferred embodiment of the present invention, there is provided a method for identification, including the steps of: (a) generating system parameters G₁, G₂, P and ê and storing the system parameters in a memory by a system administrator, wherein G₁ and G₂ are cyclic groups of order m, P is a generator on the cyclic group G₁, ê is a bilinear map defined as ê: G₁×G₁ [symbol] G₂; (b) generating a private key <a₁, a₂, . . . aₙ> and a public key v and storing the public key v in the memory by a prover or the system administrator, wherein a₁, a₂, . . . aₙ are randomly chosen in Zₘ* where Zₘ* is a multiplicative group of order m; (c) generating random numbers r₁, r₂, . . . rₙ∈Zₘ* for obtaining an evidence (x, Q) and sending the evidence (x, Q) to a verifier by the prover; (d) receiving the evidence (x, Q), selecting a randomly selected number ω□Zₘ* to obtain a query R, storing the evidence (x, Q) and the randomly selected number ω in the memory and sending the query R to the prover by the verifier; (e) receiving the query R, computing a temporary value S to obtain a response Y and sending the response Y to the verifier by the prover; (f) determining a legitimacy of the prover by employing the system parameters G₁, G₂, P and ê, the public key v, the evidence (x, Q) and the randomly selected number ω by the verifier.

### BRIEF DESCRIPTION OF THE DRAWINGS

The above and other objects and features of the present invention will become apparent from the following description of preferred embodiments given in conjunction with the accompanying drawings, in which:

FIG. 1 represents a conceptual diagram of interactions among participants of an identification scheme in accordance with the present invention;

FIG. 2 depicts a flow chart showing a protocol of an identification scheme in accordance with the present invention; and

FIG. 3 illustrates a flow chart showing a method for identification based on bilinear Diffie-Hellman problem in accordance with a preferred embodiment of the present invention.

### DETAILED DESCRIPTION OF THE PREFERRED EMBODIMENTS

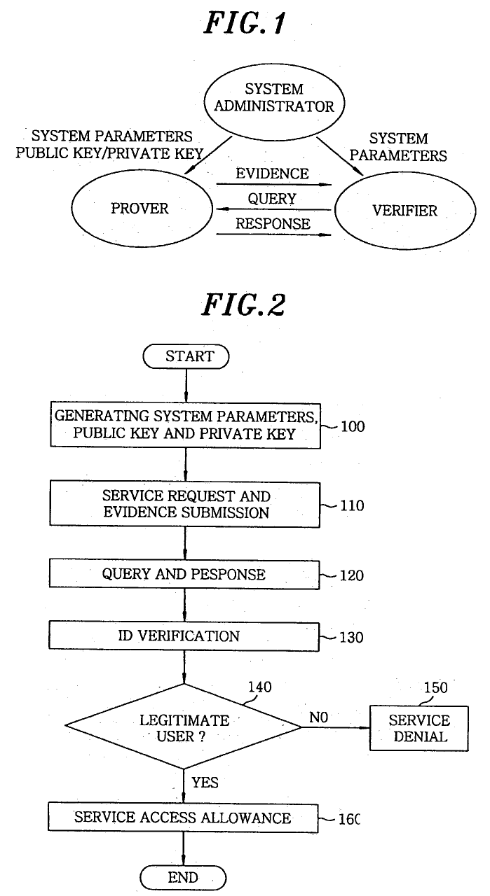

Referring to FIG. 1, there is illustrated a conceptual diagram of interactions among participants of an identification scheme in accordance with the present invention. The participants, which may be implemented by using computer systems, are a prover, a verifier and a system administrator.

Each of the participants plays its role as follows. The system administrator, only active during system initialization, generates and discloses system parameters. In some cases, the system administrator may also generate a pair of public and private keys for the prover using the system parameters to thereby send the generated keys via a secure channel. In other cases, the prover may generate the pair of public and private keys. The prover tries to prove itself a legitimate user by submitting some information to the verifier. The verifier verifies a validity of the submitted information with reference to the system parameters, and then determines whether the prover is a legitimate user by means of the submitted information and the public key.

Referring to FIG. 2, the identification scheme in accordance with the present invention includes the steps for generating system parameters and a pair of public and private keys (step 100); requesting a service and submitting an evidence to the verifier by the prover (step 110); performing query and response by the prover and the verifier (step 120); performing ID verification by the verifier (step 130); the determining the prover's legitimacy by the verifier (step 140); and performing service denial or access allowance by the verifier (step 150 or 160).

In the step for generating system parameters and the pair of public and private keys (step 110), the system administrator discloses the system parameters to be shared by both the prover and the verifier. More particularly, cyclic groups G₁ and G₂ of order m, and a generator P on the cyclic group G₁ are randomly selected. And next, a bilinear map is defined in relation to the two cyclic groups. Besides, the prover or the system administrator generates the public and the private keys of the prover.

In the step for service request and evidence submission (step 120), the prover generates random numbers to thereby submit the evidence by using the system parameters disclosed by the system administrator.

Subsequently, the step for query and response (step 130), which includes the step for making the verifier send the query to the prover and the step for letting the prover compute the response by use of the private key and the query to thereby send the response to the verifier, is performed.

Thereafter, the steps for ID verification (step 130) and legitimacy determination (step 140) are performed sequentially, and then the step for service denial (step 150) or allowance (step 160) follows. The verifier examines the query and the public key corresponding to the prover's private key (step 130) and determines the prover's legitimacy (step 140). Then, a service access is denied if the prover is determined to be illegitimate (step 150) and allowed otherwise (step 160).

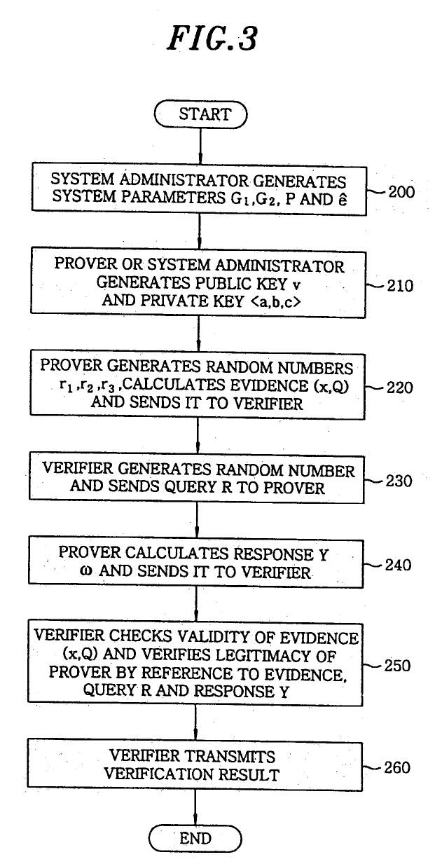

Hereinafter, a method for identification based on bilinear Diffie-Hellman problem in accordance with a preferred embodiment of the present invention will be explained in more detail with reference to FIG. 3.

First, the system administrator generates system parameters, such as G₁, a group of points on an elliptic curve, and G₂, a finite field, each of G₁ and G₂ having an order m (step 200). Next, a generator P on the cyclic group G₁ is selected randomly. And then, a transformed bilinear map is defined. This map is expressed as the following equation.

ê: G₁×G₁ [symbol] G₂ Eq. (1)

All the system parameters, G₁, G₂, P and ê, are stored in a memory.

Next, the prover or the system administrator generates a public key and a private key by using the system parameters (step 210). Random values a, b, and c belonging to Zₘ* , where Zₘ* is a multiplicative group of order m, are chosen as the private key. Employing the following equation, the public key v is obtained.

v=ê(P, P)^{abc} Eq. (2)

The prover or the system administrator publishes the public key v, while the private key being kept secret. The published public key can be obtained by the verifier whenever needed. The public key is stored in the memory.

Subsequently, the prover selects random numbers r₁, r₂, r₃□Zₘ* and generates an evidence for identifying the prover by computing the following equation (step 220).

$$\begin{matrix}x = {\hat{e} ( P , P )}^{{r}_{1} {r}_{2} {r}_{3}} , & Q = {r}_{1} {r}_{2} {r}_{3} P\end{matrix} \qquad Eq . ( 3 )$$

The prover sends the evidence (x, Q) to the verifier. The evidence includes two evidence values, i.e., a first evidence value

$$x = {\hat{e} ( P , P )}^{{r}_{1} {r}_{2} {r}_{3}}$$

and a second evidence value Q=r₁r₂r₃P, so that the random numbers r₁, r₂ and r₃ can be effectively protected from forgery or alteration.

The verifier receives the evidence (x, Q), selects a randomly selected number ω□Zₘ* and computing a query R to thereby send it to the prover (step 230). The evidence (x, Q) and the randomly selected number ω are stored in the memory. For keeping the query safe from being forged or changed during transmission, the randomly selected number ω is transformed into a value R belonging to the cyclic group G₁ to be sent as the query. The query R can be obtained by using the following equation.

R=_{ω}P Eq. (4)

Next, the prover receives the query R and then calculates a temporary value S by employing the following equation (step 240).

S=r₁r₂r₃R Eq. (5)

Thereafter, the prover computes a response Y to submit it to the verifier, wherein the temporary value S is used for protecting the response Y from forgery or change during a transmission. The computation of the response Y is performed as the following, equation.

Y=abcP+(a+b+c)S Eq. (6)

As shown in Eq. (6), only three arithmetic operations, i.e., two scalar multiplications (for the terms abcP and (a+b+c)S) and one addition (for the term, abcP+(a+b+c)S), are sufficient for generating the response Y, so that a computational overhead can be reduced in accordance with the present invention.

The verifier receives the response Y and then checks a validity of the prover by using the following equation (step 250).

x=ê(P,Q) Eq. (7)

If Eq. (7) is not established, the prover is an invalid user; otherwise, the following equation is computed.

ê(Y,P)=v ê(aP+bP+cP,Q)^{ω} Eq. (8)

If Eq. (8) is true, the prover is a legitimate user; if not, an illegitimate user.

Finally, the verifier sends the prover the above verification result, i.e., a service denial for an invalid or illegitimate user and an access allowance for a legitimate user (step 260).

As described above, the identification scheme of the present invention enables the prover to prove himself a legitimate user after only three times of interactions without disclosing his private information.

Although the number of elements of the private key is three and the number of the random numbers is three in the preferred embodiment of the present invention, the number of elements of the private key and the number of the random numbers can be changed to other numbers.

While the invention has been shown and described with respect to the preferred embodiments, it will be understood by those skilled in the art that various changes and modifications may be made without departing from the spirit and the scope of the invention as defined in the following claims.

What is claimed is:

1. A method for identification, comprising the steps of.
(a) generating system parameters G₁, G₂, P and ê and storing the system parameters in a memory by a system administrator, wherein G₁ and G₂ are cyclic groups of order m, P is a generator on the cyclic group G₁, ê is a biliniear map defined as
ê: G_{1×G}₁ [symbol] G₂;
(b) generating a private key <a, b, c> and a public key v and storing the public key v in the memory by a prover or the system administrator, wherein a, b and c are randomly chosen in Zₘ* where Zₘ* is a multiplicative group of order m;
(c) generating random numbers r₁, r₂, r₃∈Zₘ* for obtaining an evidence (x, Q) and sending the evidence (x, Q) to a verifier by the prover;
(d) receiving the evidence (x, Q), selecting a randomly selected number ω□Zₘ* to obtain a query R, storing the evidence (x, Q) and the randomly selected number ω in the memory and sending the query R to the prover by the verifier;
(e) receiving the query R, computing a temporary value S to obtain a response Y and sending the response Y to the verifier by the prover; and
(f) determining a legitimacy of the prover by employing the system: parameters G₁, G₂, P and ê, the public key v, the evidence (x, Q) and the randomly selected number ω by the verifier.

2. The method of claim 1, wherein, in the step (b), the public key v is obtained by
v=ê(P,P)^{abc}.

3. The method of claim 2, wherein, in the step (c), the evidence (x, Q) includes a first evidence value
$$x = {\hat{e} ( P , P )}^{{r}_{1} {r}_{2} {r}_{3}}$$
and a second evidence: value
Q=r₁r₂r₃P.

4. The method of claim 3, wherein, in the step (d), the query R is obtained by
R=₁₀₇P.

5. The method of claim 4, wherein, in the step (e), the temporary value S is obtained by S=r₁r₂r₃R and the response Y is obtained by
Y=abcP+(a+b+c)S.

6. The method of claim 5, wherein the verifier determines the legitimacy of the prover by verifying
$$\begin{matrix}\hat{e} ( Y , P ) = \hat{e} ( abcP + ( a + b + c ) S , P ) \\ = \hat{e} ( abcP + ( a + b + c ) {r}_{1} {r}_{2} {r}_{3} R , P ) \\ = \hat{e} ( abcP + ( a + b + c ) {r}_{1} {r}_{2} {r}_{3} ω P , P ) \\ = \hat{e} ( ( abc + ( a + b + c ) {r}_{1} {r}_{2} {r}_{3} ω ) P , P ) \\ = {\hat{e} ( P , P )}^{abc + ( a + b + c ) {r}_{1} {r}_{2} {r}_{3} ω} \\ = {\hat{e} ( P , P )}^{abc} \cdot {\hat{e} ( P , P )}^{( a + b + c ) {r}_{1} {r}_{2} {r}_{3} ω} \\ = {\hat{e} ( P , P )}^{abc} \cdot {\hat{e} ( P , {r}_{1} {r}_{2} {r}_{3} P )}^{( a + b + c ) ω} \\ = {\hat{e} ( P , P )}^{abc} \cdot {\hat{e} ( P , Q )}^{( a + b + c ) ω} \\ = {\hat{e} ( P , P )}^{abc} \cdot {\hat{e} ( ( a + b + c ) , PQ )}^{ω} \\ = {\hat{e} ( P , P )}^{abc} \cdot {\hat{e} ( aP + bP + cP , Q )}^{ω} \\ = v \cdot {\hat{e} ( aP + bP + cP , Q )}^{ω}\end{matrix}$$

7. A method for identification, comprising the steps of:
(a) generating system parameters G₁, G₂, P and ê and storing the system parameters in a memory by a system administrator, wherein G₁ and G₂ are cyclic groups of order m, P is a generator on the cyclic group G₁, ê is a bilinear map defined as
ê: G₁×G₁ [symbol] G₂;
(b) generating a private key <a₁, a₂, . . . aₙ> and a public key v and storing the public key v in the memory by a prover or the system administrator, wherein a₁, a₂, . . . aₙ are randomly chosen in Zₘ* where Zₘ* is a multiplicative group of order m;
(c) generating random numbers r₁, r₂, . . . rₙ∈Zₘ* for obtaining an evidence (x, Q) and sending the evidence (x, Q) to a verifier by the prover;
(d) receiving the evidence (x, Q), selecting a randomly selected number a ω□Zₘ* to obtain a query R, storing the evidence (x, Q) and the randomly selected number ω in the memory and sending the query R to the prover by the verifier;
(e) receiving the query R, computing a temporary value S to obtain a response Y and sending the response Y to the verifier by the prover; and
(f) determining a legitimacy of the prover by employing the system parameters G₁, G₂, P and ê, the public key v, the evidence (x, Q) and the randomly selected number ω by the verifier.

8. The method of claim 7, wherein, in the step (b), the public key v is obtained by v=ê(P, P)^{a}^{₁}^{a}^{₂} ^{. . . a}^{ₙ}.

9. The method of claim 8, wherein, in the step (c), the evidence (x, Q) includes a first evidence value
v=ê(P, P)^{r}^{₁}^{r}^{₂} ^{. . . r}^{ₙ} and a second evidence value Q=r₁r₂ . . . rₙP.

10. The method of claim 9, wherein, in the step (d), the query R is obtained by
R=₁₀₇P.

11. The method of claim 10, wherein, in the step (e), the temporary value S is obtained by S=r₁r₂ . . . rₙR and the response Y is obtained by Y=a₁a₂ . . . aₙP+(a₁+a₂ +. . . +aₙ)S.

12. The method of claim 11, wherein the verifier determines the legitimacy of the, prover by verifying
$$\begin{matrix}\hat{e} ( Y , P ) = \hat{e} ( {a}_{1} {a}_{2} … {a}_{n} P + ( {a}_{1} + {a}_{2} + … + {a}_{n} ) S , P ) \\ = \hat{e} ( {a}_{1} {a}_{2} … {a}_{n} P + ( {a}_{1} + {a}_{2} + … + {a}_{n} ) {r}_{1} {r}_{2} … {r}_{n} R , P ) \\ = \hat{e} ( {a}_{1} {a}_{2} … {a}_{n} P + ( {a}_{1} + {a}_{2} + … + {a}_{n} ) {r}_{1} {r}_{2} … {r}_{n} ω P , P ) \\ = \hat{e} ( ( {a}_{1} {a}_{2} … {a}_{n} + ( {a}_{1} + {a}_{2} + … + {a}_{n} ) {r}_{1} {r}_{2} … {r}_{n} ω ) P , P ) \\ = {\hat{e} ( P , P )}^{{a}_{1} {a}_{2} … {a}_{n} + ( {a}_{1} + {a}_{1} + … + {a}_{n} ) {r}_{1} {r}_{2} … {r}_{n} ω} \\ = {\hat{e} ( P , P )}^{{a}_{1} {a}_{2} … {a}_{n}} \cdot {\hat{e} ( P , P )}^{( {a}_{1} + {a}_{1} + … + {a}_{n} ) {r}_{1} {r}_{2} … {r}_{n} ω} \\ = {\hat{e} ( P , P )}^{{a}_{1} {a}_{2} … {a}_{n}} \cdot {\hat{e} ( P , {r}_{1} {r}_{2} … {r}_{n} P )}^{( {a}_{1} + {a}_{1} + … + {a}_{n} ) ω} \\ = {\hat{e} ( P , P )}^{{a}_{1} {a}_{2} … {a}_{n}} \cdot {\hat{e} ( P , Q )}^{( {a}_{1} + {a}_{1} + … + {a}_{n} ) ω} \\ = {\hat{e} ( P , P )}^{{a}_{1} {a}_{2} … {a}_{n}} \cdot {\hat{e} ( ( {a}_{1} + {a}_{2} + … + {a}_{n} ) , PQ )}^{ω} \\ = {\hat{e} ( P , P )}^{{a}_{1} {a}_{2} … {a}_{n}} \cdot {\hat{e} ( {a}_{1} P + {a}_{2} P + … + {a}_{n} P , Q )}^{ω} \\ = v \cdot {\hat{e} ( {a}_{1} P + {a}_{2} P + … + {a}_{n} P , Q )}^{ω} .\end{matrix}$$
